(19) United States
(12) Patent Application Publication
(10) Pub. No.: US 2004/0161488 A1
(43) Pub. Date: Aug. 19, 2004

(54) Nozzle mechanism for cold runner device in injection mold arrangement

(76) Inventors: Yoshiharu Matsumoto, Osaka (JP); Yoshikazu Tsujimoto, Osaka (JP)

Correspondence Address: JORDAN AND HAMBURG LLP, 122 EAST 42ND STREET, SUITE 4000, NEW YORK, NY, 10168, US

(21) Appl. No.: 10/723,157

(22) Filed: Nov. 26, 2003

(30) Foreign Application Priority Data
Feb. 17, 2003 (JP) 2003-38878

(51) Int. Cl. B29C 45/07; B29C 45/74

(52) U.S. Cl. 425/549; 425/574

(57) ABSTRACT

In an injection mold arrangement including a mold unit forming a cavity, a cold runner block and a nozzle block, a nozzle tip of the cold runner block is constructed to be brought into pressure contact with the cavity side by feed pressure of a molding material, e.g. rubber, thereby enabling it to make adjustment of the contact state virtually unnecessary, prevent leakage of the material, and facilitate the stage switching work during molding. To that end, the nozzle block is constructed so that a cylindrical piece is secured to an internal hole of a nozzle body by threading means; a nozzle piece having a gate is loose fitted inside the cylindrical piece with its lower tip protruded downwardly to be capable of advancing or receding so that the lower tip may be made into pressure contact with the perimeter of an injection port to the cavity by the feed pressure.

### BACKGROUND OF THE INVENTION

1. Field of the Invention

This invention relates to a nozzle mechanism for a cold runner device in an injection mold arrangement principally for use in vulcanization molding of rubber products.

2. Description of the Related Art

As one of vulcanization molding methods for fabricating vibration-proof rubber parts, boots for protection of the articulated part of a shift lever, etc. for automobiles and any other rubber products, for example, there is known a vulcanization molding method which comprises injecting unvulcanized rubber material from the nozzle of an injection machine to charge it through a runner and a nozzle into the cavity of a mold, followed by vulcanization molding.

In this vulcanization molding, an injection mold equipped with a cold runner device is generally used in order to prevent the progress of vulcanization during stopping of feeding in the runner channel where the rubber material compound injected from a nozzle of injection machine is fed to the cavity, namely during stopping of feeding every cycle of vulcanization molding (cf. for example JP Patent Application Publications 5(1993)-185473, 5-269807, 7-156200, 9-70853, 2000-28029, etc.).

An injection mold equipped with a cold runner device is, as is exemplified in FIG. 15, comprised of a mold unit 210 including both upper and lower molds 212, 213 capable of opening and closing and jointly forming a mold cavity 211; and a cold runner block 220 clamped through a thermal insulation layer 228 to the upside of the upper mold 212 and forming a cold runner 221 feeding a rubber material injected from the nozzle of an injection machine to the aforesaid cavity 211, and at the underside of the cold runner block 220, further provided with a nozzle block 230 constituting a nozzle for injecting the rubber material from the cold runner 221 to the cavity 211.

The upper and lower molds 212, 213 of the mold unit 210 are provided with flow ducts 217 passing a heat transfer medium for heating the mold unit 210. On the other hand, upper and lower runner plates 222, 223 jointly constituting the cold runner block 220 are provided with flow ducts 227a, 227b for passing a cooling medium. The nozzle block 230 holds a required space 218 around it in a hollow portion 214 of the upper mold 211 and is constructed so that only a nozzle tip 230a may abut on a portion of an injection port 215 of the upper mold 212 to the cavity 211 in an opposed manner.

In the opposed abutment state mentioned above, it is required to mate the nozzle tip with the injection port 215 to prevent leakage of the rubber material. To that end, for example, a portion of the upper mold 212 located at the injection port 215 to the cavity on the bottom of the hollow portion is recessed at 219 as illustrated in FIG. 15, and the nozzle tip 230a is fitted to the recessed portion 219 so that the tip face may abut on the bottom of the recessed portion 219.

Due to the fact that the nozzle mechanism of the conventional cold runner device stated above was constructed so that the nozzle tip 230a is formed integrally with the nozzle block 230 in a stationary state, when clamping the cold runner block 220 to the upper mold 212, however, it was not easy to adjust the opposed abutment of the nozzle tip 230a on the injection port 215 and its perimeter of the upper mold 212 to the cavity 211. In a particular case of a multi-cavity mold, the adjustment work was laborious and time-consuming and, in the event of an incomplete adjustment, there was a danger that leakage of the rubber material from the abutment junction occurs.

Further at the time of a stage switching for the purposes of altering the size or shape of rubber products intended for vulcanization molding, the adjustment of the opposed abutment at the nozzle tip 230a was not easy, so that the rubber material or the like was liable to leak, which was responsible for the occurrence of troubles.

Moreover the cleaning of the nozzle portion was necessary to conduct by disassembling the cold runner block 220 and the nozzle block 230 after removing the vulcanization mold out of a pressure device, and consequently, its work was troublesome.

### SUMMARY OF THE INVENTION

In view of the above-described problems this invention has been made, and the invention is concerned with an nozzle mechanism for a cold runner device of an injection mold arrangement mainly for vulcanization molding rubber products or any other molded parts. In the nozzle mechanism, a movable type of nozzle piece is substituted for the conventional stationary type of nozzle tip, and the nozzle piece is constructed so that a nozzle tip of it may be securely brought into pressure contact with the perimeter of an injection port to a mold cavity by utilizng the feed pressure of a molding material, whereby adjustment of the opposed abutment state is facilitated or unneeded, leakage of the molding material such as rubber is prevented, a stage switching work is made easier, and cleaning of the nozzle portion can be done with ease, as well.

The present invention for solving the foregoing problems is directed to an injection mold arrangement which comprises a mold unit including an upper and a lower molds jointly forming a mold cavity; and a cold runner device comprising a cold runner block attached to the upside of the upper mold through a thermal insulation layer and forming a cold runner through which to feed a molding material injected from a nozzle of an injection machine, and a nozzle block attached to the underside of the cold runner block and constituting an injection nozzle for charging the molding material through the cold runner to the cavity of the mold unit. And the cold runner device is characterized by a nozzle mechanism constructed so that the nozzle block includes a nozzle body having an internal hole communicating with the cold runner and secured to the underside of the cold runner block and a nozzle piece having a gate comprised of a throttle-shaped orifice held in a lower part of the nozzle body, the nozzle piece being capable of advancing or retreating in the feeding direction of the molding material with its nozzle tip protruded, and the lower tip face of the nozzle piece is made into pressure contact with the perimeter of the injection port at the upper mold to the cavity by reason of the feeding pressure of the molding material.

According to the nozzle mechanism with this construction, the nozzle piece is held at the nozzle tip portion to be capable of advancing or receding in the feeding direction of the molding material relative to the nozzle body. Because of this, even if the tip face of the nozzle piece is not completely in contact with the perimeter of the injection port at the upper mold to the cavity when attaching the cold runner block to the upper mold of the mold unit, upon molding the nozzle piece advances outside while being urged by a feeding pressure of the molding material, whereby the tip face can be entirely and strongly brought into pressure contact with the perimeter of the injection port to the cavity. As a consequence there is no danger of rubber leaking.

Further because of that, when assembling the cold runner block and the upper mold by clamping or by stage switching, there is no need of abutting tightly the tip face of the nozzle piece with the perimeter of the injection port at the upper mold to the cavity in an opposed manner. The adjustment of the opposed abutment state is thus virtually or utterly unneeded, and the assembling work or stage switching work can be readily carried out.

In the nozzle mechanism of the cold runner device described above, it is alternatively possible to constitute the nozzle mechanism so that a cylindrical piece is secured to the internal hole of the nozzle body of the nozzle block by threading engagement means with its lower tip protruded downwardly, the nozzle piece is loose fitted inside the cylindrical piece and held to be capable of advancing or retreating freely in the feeding direction of the molding material, and the tip portion of the nozzle piece is protruded downwardly of the lower extremity of the cylindrical piece.

In that case, the incorporation of the nozzle piece is facilitated and besides, in cleaning the nozzle portion, it will suffice to remove the mold unit from the cold runner block and to release the cylindrical piece from the nozzle body by threading disengagement operation. Thus it is possible to disassemble and clean the nozzle portion while the cold runner block remains present in the pressure device. The exchange of the nozzle piece can be done likewise easily as well.

In the preceding nozzle mechanism of the cold runner device, the cylindrical piece is configured so that its lower end opening has a slightly smaller diameter than its upper portion and is internally formed with a step; the nozzle piece loose fitted in the cylindrical piece is configured to be smaller in diameter at its lower part than its upper part so that the lower part can be loose fitted in the aforesaid lower end opening and provided so that a stepped portion between the upper part and the lower part may be engaged with the step in the inner periphery of the cylindrical piece, thus regulating the downward displacement of the nozzle piece. The nozzle piece thereby can be held in place without releasing from the cylindrical piece downwardly.

The nozzle piece is preferred that an upper nozzle hole portion above the gate be larger than a lower nozzle hole portion below the gate, assuming a tapered form (its divergent angle or gradient is large). Being constituted like this, the nozzle piece is susceptible to the feeding pressure of the molding material, so that the nozzle piece can be positively and reliably advanced outside and brought into press contact with the perimeter of the injection port, as described above.

In the preceding nozzle mechanism of the cold runner device, the nozzle block is provided with a flow duct for a cooling medium, which may be formed by a helical passage running around the internal hole. As a flow duct for the cooling medium for cooling the nozzle block, it is conceivable to form the flow duct by a mere cylindrical space surrounding the internal hole, but in that case the cooling medium flows in a manner short-cutting only an axially upper extremity portion of the cylindrical space, as a result of which it is likely that an even cooling is not performed in the axial entirety of the cylindrical space. However due to the constitution that the flow duct is constructed of the helical passage running around the internal hole as described above, it is possible to cool the nozzle block homogeneously in the axial entirety of the flow duct, and ultimately to prevent an undesired progress of vulcanization of rubber within the nozzle block.

### BRIEF DESCRIPTION OF THE DRAWINGS

FIG. 1 is a sectional view showing schematically an injection mold arrangement equipped with a cold runner device having an improved nozzle mechanism pertaining to a first embodiment of the invention.

FIG. 2 is a partly enlarged sectional view of the aforesaid mold arrangement in FIG. 1.

FIG. 3 is an enlarged sectional view illustrating a nozzle block of the preceding mold arrangement.

FIG. 4 is a cross-sectional view of the preceding nozzle block showing a cylindrical piece and a nozzle piece thereof in a separated state.

FIG. 5 is a partial sectional view of the aforesaid mold arrangement upon molding.

FIG. 6 is a schematic front elevational view of an overall manufacturing apparatus for a vibration-proof rubber part in this embodiment.

FIG. 7 is a plan view showing the layout of respective stages in the preceding manufacturing apparatus with partly omitted.

FIG. 8 is a sectional view of the preceding manufacturing apparatus showing the molding of an outer layer of the aforesaid rubber part at a first molding stage.

FIG. 9 is a perspective view showing one example of a bushing with two-layer structure intended to be fabricated in the same embodiment.

FIG. 10 is a sectional view of FIG. 9 taken along X-X line.

FIG. 11 is a schematic sectional view showing an injection mold arrangement equipped with a cold runner device having an improved nozzle mechanism pertaining to a second embodiment of the invention.

FIG. 12 is a partial enlarged sectional view of the mold arrangement in FIG. 11.

FIG. 13 is a partial sectional view of the preceding mold arrangement upon molding.

FIG. 14 is a sectional view of the nozzle block of the preceding mold arrangement showing its cylindrical piece and nozzle piece in a separated state.

FIG. 15 is a partial enlarged section of a conventional injection mold provided with a conventional cold runner device and nozzle mechanism.

### DESCRIPTION OF THE PREFERRED EMBODIMENTS

The best modes for carrying the invention into effect will be hereinafter described with reference to the accompanying drawings, but this invention shall not be limited to these embodiments.

[First Embodiment]

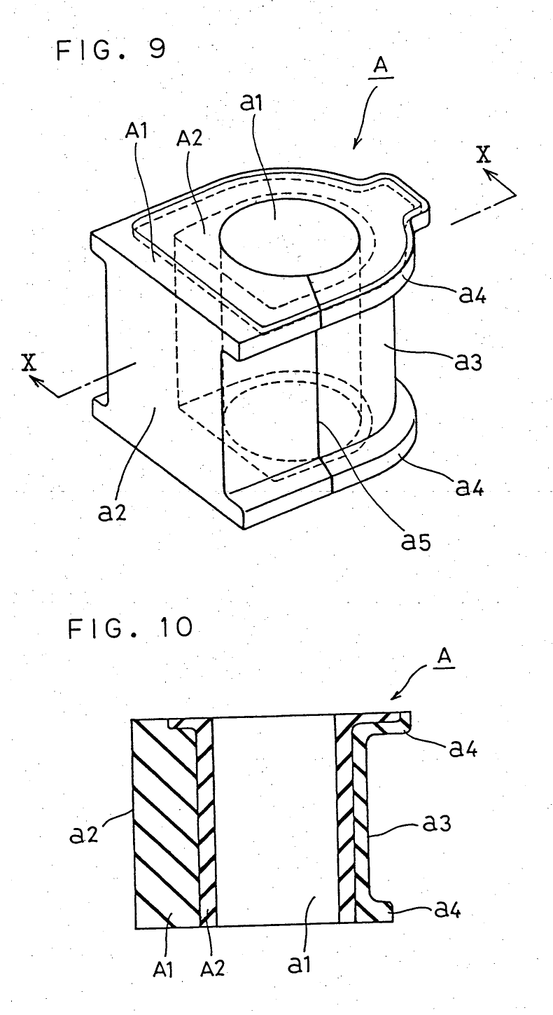

A first embodiment is concerned with a bushing with a two-layer structure used for a stabilizer bushing of automobiles. This two-layer structured bushing A is, as illustrated in FIGS. 9 and 10, a cylindrical bushing, which has internally a hollow a1, through which a stabilizer bar is adapted to be inserted, and is configured, at its drum part, of a flat face a2 serving as an abutment face on an attachment face to the vehicle body and of a generally U-shaped peripheral face a3 lining to the flat face a2. The bushing A is formed of an inner rubber layer A2 of a rubber material having a high sliding ability and an outer rubber layer A1 of a rubber material having a higher rigidity and hardness than the inner rubber layer A2 and further provided with flanges a4, a4 at its axially both ends. The reference character a5 designates a slit for installing to the stabilzer bar.

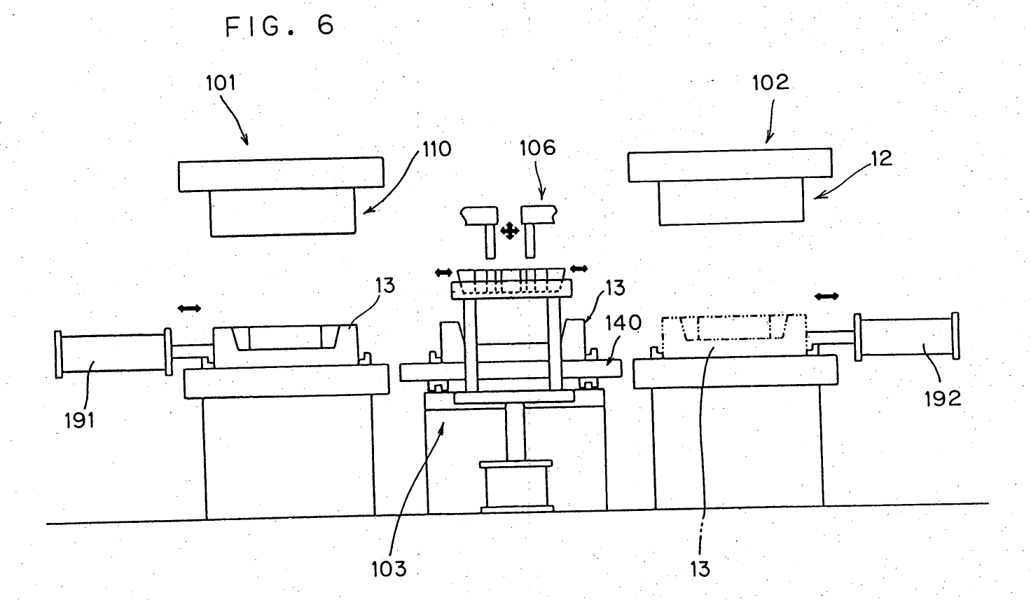

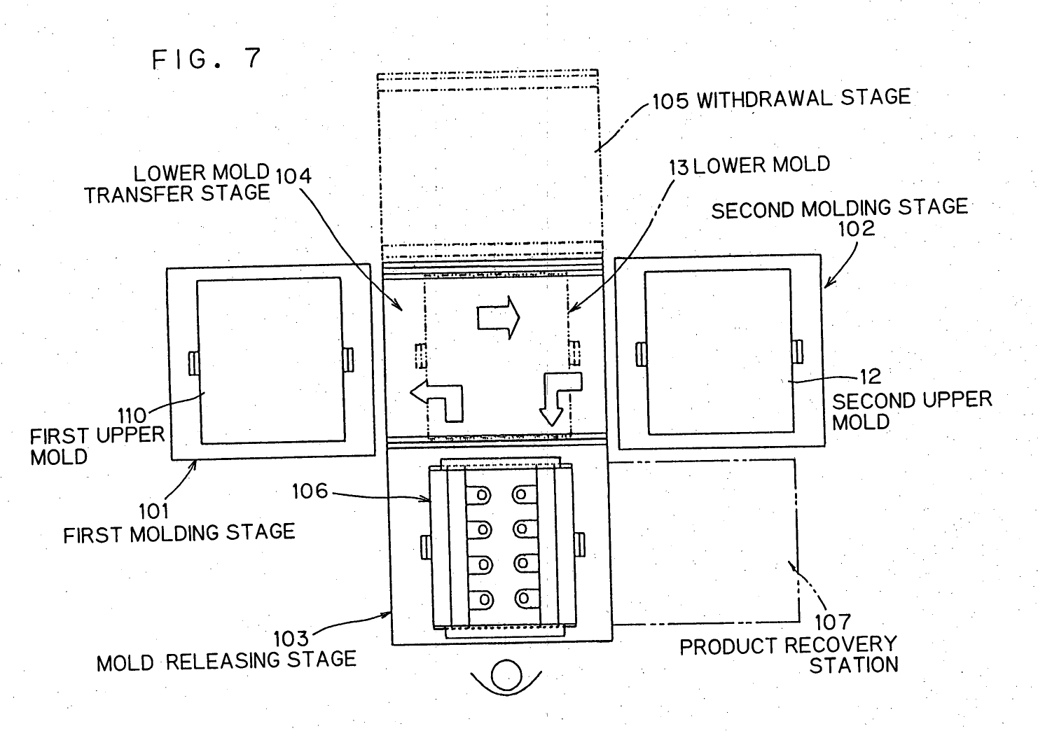

A manufacturing apparatus for fabricating the bushing A comprises, as schematically shown in FIGS. 6 and 7, a first molding stage 101 forming the outer rubber layer A1, a second molding stage 102 molding the inner rubber layer A2, a mold releasing stage 103 removing the molded product (bushing A) out of a mold unit, a transfer stage of a lower mold 104 linking to the mold releasing stage 103, a withdrawal (retracting) stage 105 for a transfer carriage as will be later described, and a product recovery station 107 recovering the mold-released product.

At the first molding stage 101 a first upper mold 110 for forming the outer rubber layer A1 is disposed to be vertically movable by means of a pressure device not shown, while at the second molding stage 102 a second upper mold 12 is disposed to be vertically movable by means of a pressure device not shown.

This manufacturing apparatus is equipped with a lower mold 13 having at its upside a mold hole conforming to the contour of the bushing A. In order to move the lower mold 13 from the first molding stage 101 to the second molding stage 102 and further to the mold releasing stage 103, the first and the second molding stages 101, 102 are provided with respective lower mold sliding devices 191, 192. The lower mold transfer stage 104 is equipped with a transfer carriage 140 which can transfer the lower mold 13 to the mold releasing stage 103 and allows the transfer from the first molding stage 101 to the second molding stage 102.

In this manufacturing apparatus, at the first molding stage 101, to the upside face of the lower mold 13 is closed a first upper mold 110 to join both together, and then the outer rubber layer A1 is vulcanization molded or half-vulcanization molded.

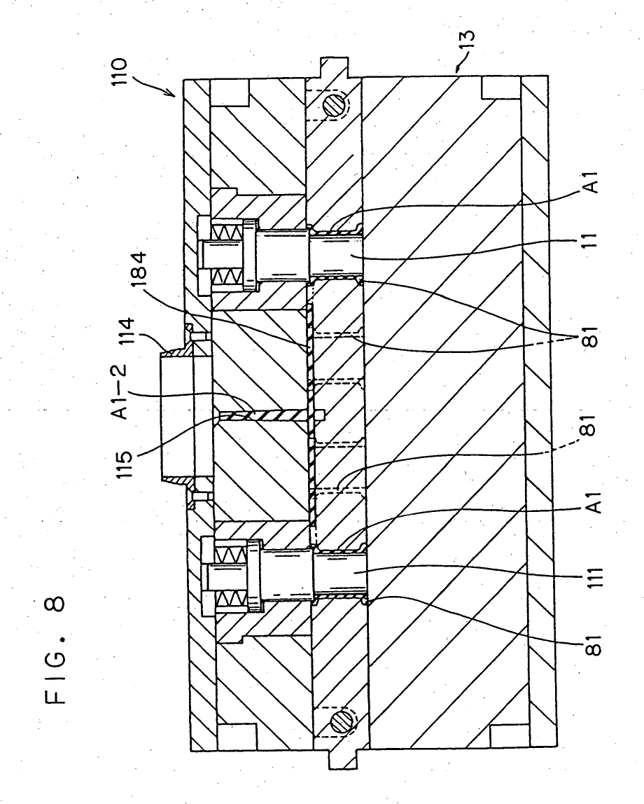

FIG. 8 represents the molding state at the first molding stage 101, where a rubber material is injected from a hot runner to each cavity. More specifically, core pins 111 are provided protruding from the underside of the first upper mold 110, and, upon joining to the lower mold 13, are inserted each into a mold hole 81 of the lower mold 13 whereby a cavity for the outer rubber layer A1 is defined between the core pin and the inner peripheral surface of the mold hole 81. A runner 184 for injecting the rubber material into each cavity is provided at the joining junction between the first upper mold 110 and the lower mold 13. The rubber material can be injected from a locating port 114 to the upside of the first upper mold 110 past a sprue 115 piercing the first upper mold 110 through the runner 184 into the cavity, whereby the outer rubber layer A1 is molded.

After this molding, the first upper mold 110 is separated from the lower mold 13, with the outer rubber layer A1 so molded remaining present in the mold hole, and the lower mold 13 is transferred to the second molding stage 102.

Subsequently at the second molding stage 102, a second upper mold 12 for the inner layer is closed to the upside of the lower mold 13 and joined together to vulcanization mold the inner rubber layer A2 inside the outer rubber layer A1 in a manner laminating it. After the molding, the second upper mold 12 is separated from the lower mold 13, as the molded product A consisting of the inner and outer rubber layers is left behind in the lower mold 13, which is in turn transferred to the mold releasing stage 103.

At the mold releasing stage 103, the molded product A is removed from the lower mold 13 by means of a mold releasing device 106, and subsequently, the lower mold 13 is transferred to the first molding stage 101. One cycle of the aforementioned steps is repeated, whereby bushings A are fabricated.

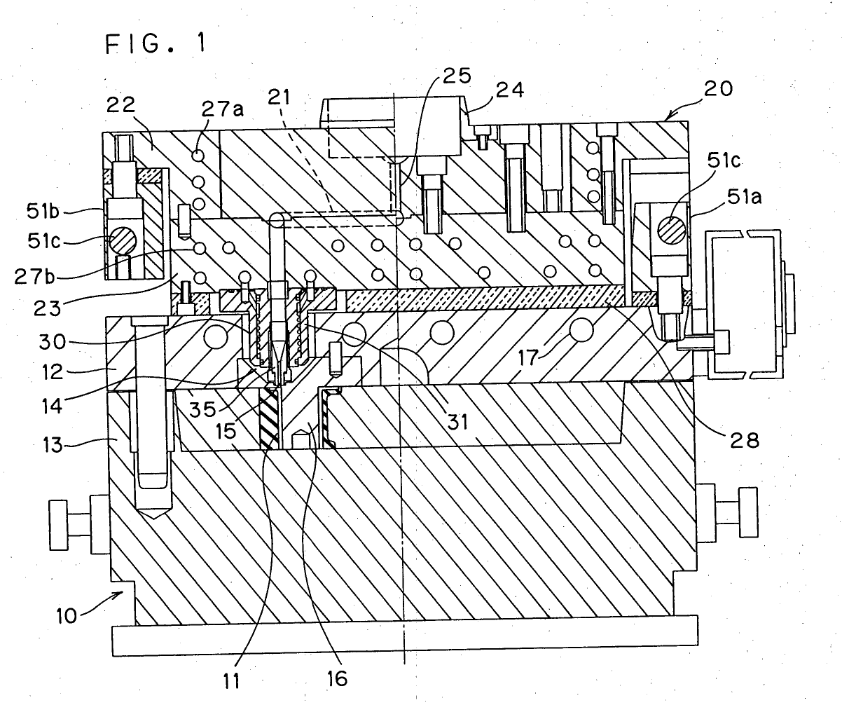

The present embodiment is particularly featured by the second molding stage 102, which will be described below in more detail with reference to FIGS. 1 to 5.

Referring to FIG. 1, the reference numeral 10 designates a mold unit having a cavity where to mold the inner rubber layer A2, the reference numeral 20 a cold runner block forming a cold runner 21 through which to feed a molding material such as unvulcanized rubber compound, and the reference numeral 30 a nozzle block.

The mold unit 10 is provided to be capable of opening or closing by the second upper mold 12 and the lower mold 13, with the upper mold 12 constructed as a movable mold connected through the cold runner to a pressure device not shown.

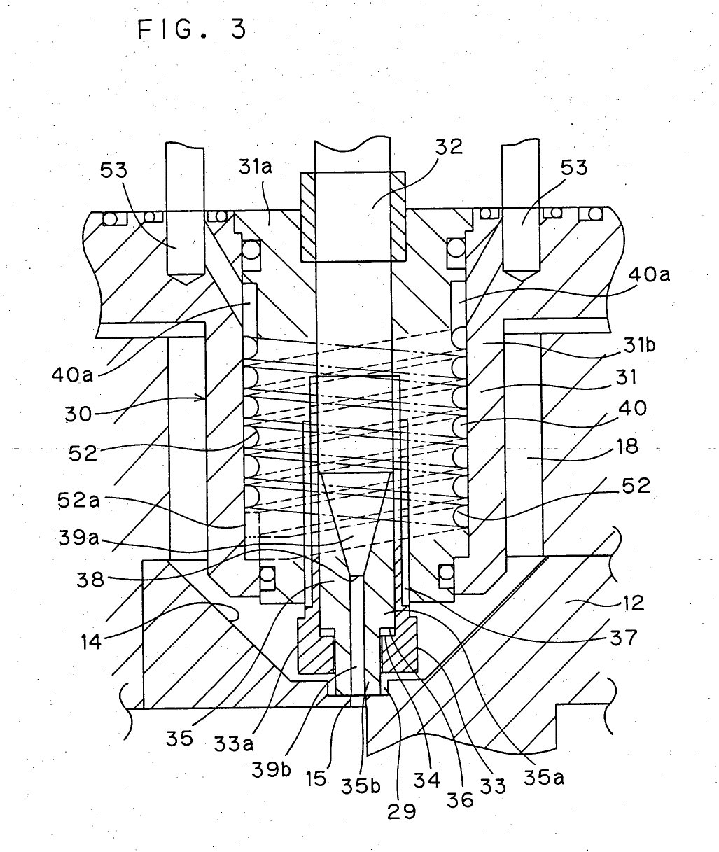

At an upper area of the upper mold 12, there are defined hollow portions 14 each for disposing therein the nozzle block 30 at the cold runner block 20 side. The hollow portion 14 is provided on its bottom face with an injection port 15 for charging the molding material into the cavity 11. As indicated in FIG. 3, in the area of the injection port 15 on the bottom of the hollow portion 14 there is formed a recessed portion 29, in which a tip portion of a nozzle piece 35 is adapted to be fitted, which will be later described,.

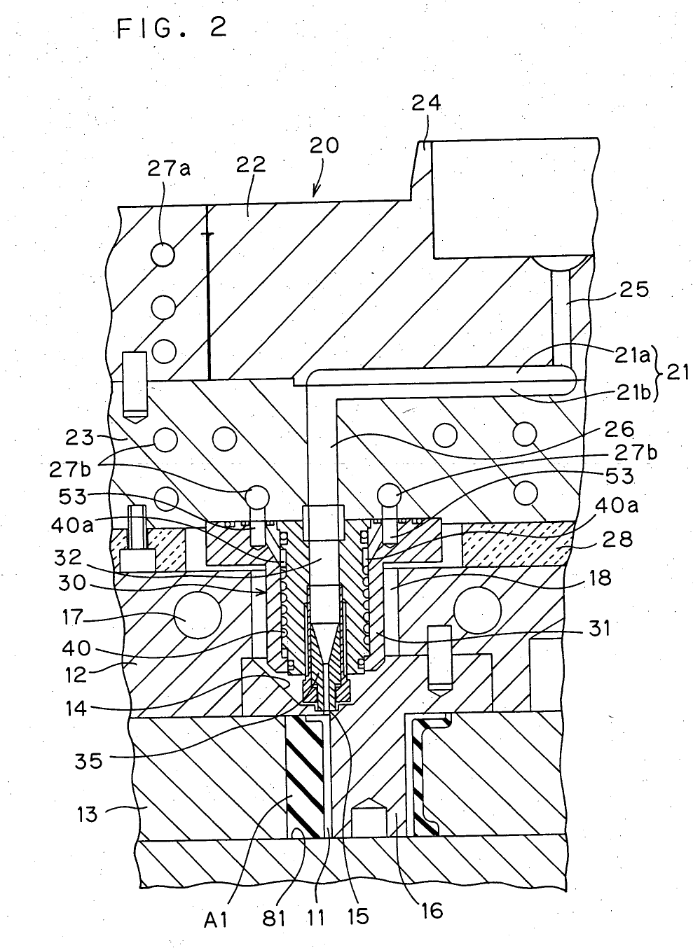

As shown in FIG. 2, at the underside of the upper mold 12, core pins 16 are provided to protrude from it. When joining to the lower mold 13, each core pin 16 is inserted into a mold hole 81 of the lower mold 13, whereby the cavity 11 for the inner rubber layer A2 is formed between the inner periphery of the outer rubber layer A1 formed at the first molding stage 101. The cavity 11 is provided generally in a plural number per one mold unit 10 depending upon the material dispensing number, and eight cavities are provided in this embodiment (cf. FIG. 7).

The upper mold 12 is formed with flow passages 17 for passing a heating medium. When a heating medium (e.g. ca. 180° C.) is flowed through the passages 17, the upper mold 12 is heated, which brings the rubber material injected in the cavities into vulcanization. On the other hand, the lower mold 13 is heated by means of a heating platen (not shown) installed at the pressure device.

The cold runner block 20 is made up of two upper and lower runner plates 22, 23 forming the cold runner 21, as will be later described, wherein to the underside of the lower runner plate 23 is attached the upper mold 12 of the aforesaid mold unit 10 through the intermediary of a thermal insulation layer 28. Specifically, a coupling block 51a disposed at the upper mold 12 and a coupling block 51b disposed at the cold runner block 20 are connected with a pin 51c passing both through, whereby the cold runner block 20 is secured to the upside of the upper mold 12. The thermal insulation layer 28 is cut out in an area corresponding to the opening of the hollow portion 14 where the nozzle block 30 is disposed.

As illustrated in FIG. 2, the upper runner plate 22 is formed at its central upside with a locating port 24, to which a nozzle of an injection machine (not shown) is joined and from which port there is formed a sprue 25 piercing the runner plate 22 up to its lower face.

Further, conforming to the underside of the upper runner plate 22 and the upside of the lower runner plate 23 joined to the former, grooves 21a, 21b for a runner are formed. The runner grooves 21a, 21b are made into mate to each other by joining of both runner plates, thereby being formed as the cold runner 21 communicating with the sprue 25. That is, the lower extremity of the sprue 25 opens at the runner groove 21a. The cold runner 21 communicates with a runner hole 26 that pierces vertically in a position located above the injection port 15 to the each cavity 11 of the mold unit 10. These upper and lower runner plates 22, 23 are provided, in the surroundings of the cold runner 21, with flow ducts 27a, 27b respectively through which to pass a cooling medium (e.g. ca. 70° C.) for cooling the cold runner 21 to a predetermined temperature so that the cold runner 21 can be maintained at a low temperature.

The foregoing nozzle block 30 is installed to be positioned in conformity with the injection port 15 to the cavity 11 in the hollow portion 14, beneath the underside of the cold runner block 20, namely in an area at the lower face of the lower runner plate 23 where the thermal insulation layer 28 is cut out. This nozzle block 30 holds a required space 18 relative to the side face of the hollow portion 14 in the outer peripheral area thereof in order to intercept the heat from the upper mold 12.

The nozzle block 30 is fixed to the underside of the runner plate 23 by any fastening means (not shown) such as bolts, and comprises a nozzle body 31 having an internal hole 32 communicating with the cold runner 21 via the runner hole 26; and a nozzle piece 35 provided in the lower part of the nozzle body 31 to protrude in the same downward sense as the feeding direction of the forming direction and held to be capable of freely advancing or retreating. The nozzle piece 35 having a throttle-shaped gate, as will be later explained, is provided so that it may be brought into press contact with the perimeter of the injection port 15 at the hollow portion 14 of the upper mold 12 by reason of the feeding pressure of the molding material.

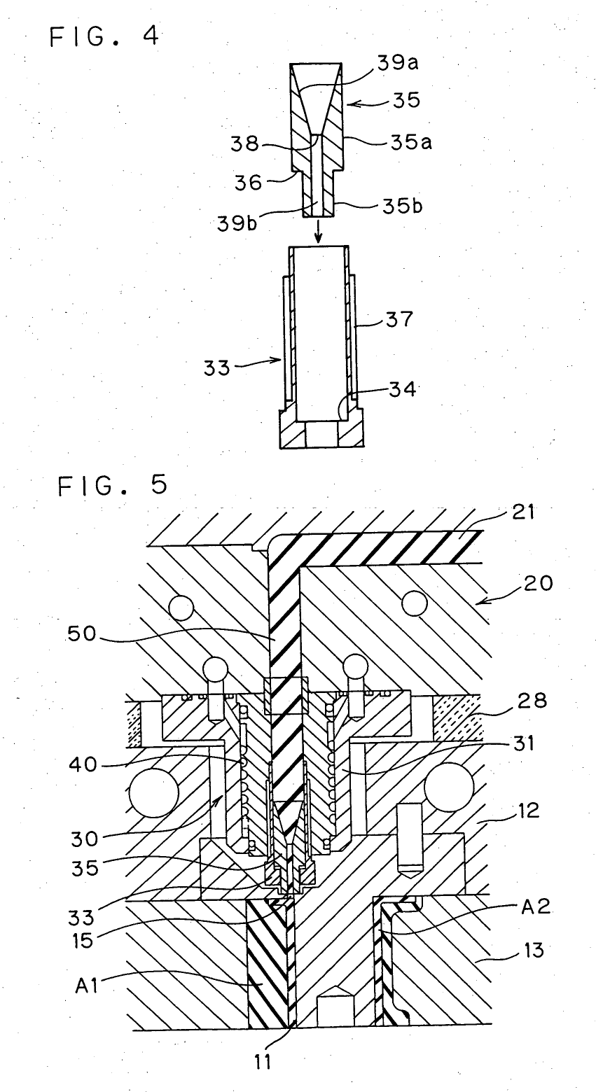

More specifically, as shown in FIGS. 3 and 4, there is further provided a cylindrical piece 33 that is inserted in the nozzle body 31 from the lower opening side of the internal hole 32 vertically extending and fixed by a threading engagement means thereby protruding at its lower extremity 33a from the nozzle body 31 downwardly. And the aforesaid nozzle piece 35 is loose fitted in this cylindrical piece 33 to be slidably movable from its upper extremity, and held to be capable of advancing or retreating in the feeding direction of the molding material, namely vertically as viewed in the figures. Usually the nozzle piece 35 is held with its lower end portion protruded from the lower extremity of the cylindrical piece 33 downwardly.

The cylindrical piece 33 has a smaller inside diameter at its lower end opening portion than at its upper part and is formed with a step 34 inside the lower end opening portion. On the other hand, the nozzle piece 35 is formed to have a smaller diameter at its lower part 35b than at its upper part 35a so that the lower part 35b may be loose fitted in the lower end opening portion of the cylindrical piece 33. In the state that the upper part 35a is sidably fitted to the upper part of the cylindrical piece 33 and the lower part 35b is slidably fitted to the lower end opening portion, a stepped overhang portion 36 formed between the upper part 35a and the lower part 35b is engaged with the step 34 in the inner periphery of the cylindrical piece 33, whereby the nozzle piece 35 is held in place so that any displacement in a further downward advancing direction may be regulated and accordingly, without releasing downwardly. The incorporation of the nozzle piece 35 into the cylindrical piece 33 is carried out in the state that the cylindrical piece 33 is disengaged from the nozzle body 31.

Alternatively the cylindrical piece 33 can be inserted from the lower end opening portion side to the internal hole 32 of the nozzle body 31, and fixed by pins or any other means so as not to be released downwardly. However in the practical working, it is preferred to releasably fit the cylindrical piece 33 to the internal hole 32 by a threading engagement means as illustrated, since that means will make the fitting or releasing operation of the cylindrical piece 33 easier. The reference numeral 37 designates the threaded engagement part of the cylindrical piece 33. The contour of the lower extremity 33a of the cylindrical piece 33 is desired to be polygonal; such as hexagonal from the viewpoint of easiness of the threading engagement operation.

When the upper mold 12 of the mold unit 10 is clamped to the underside of the cold runner block 20 in either case, the nozzle piece 35 is installed as shown in FIG. 3 so that the tip portion of the nozzle piece 35 may protrude downwardly from the nozzle body 31 or the lower extremity of the cylindrical piece 33 by a predetermined length to abut on the perimeter of the injection port 15 at the upper mold 12 in opposed manner and may retain a distance between the stepped overhang portion 36 at the outer periphery of the nozzle piece 35 and the step 34 in the inner periphery of the cylindrical piece 33.

The nozzle piece 35 is internally provided with a gate (cold gate) 38 comprised of a throttle-shaped orifice in a required position of the nozzle hole, so that after vulcanization molding, upon releasing from mold, the molded product can be cut off in the part of the gate 38. The nozzle hole part 39a above the gate 38 assumes a larger tapered form than the nozzle hole 39b below the gate 38, for example a tapered form whose tapering angle is on the order of 30 degrees, and the nozzle hole part 39a is formed to have a larger diameter (ca. 2 to 6 times) at the upper extremity thereof than at the lower extremity of the nozzle hole part 39b, whereby the nozzle piece 35 can receive sufficiently the feeding pressure of the molding material and can press contact more strongly with the perimeter of the injection port.

Further the nozzle body 31 is provided at its outer peripheral area with a flow duct 40 so that the nozzle block 30 can be cooled. The flow duct 40 is formed by a passageway extending axially and helically around the internal hole 32.

More specifically as shown in FIG. 3, the nozzle body 31 includes an inner member 31a of hollow pillar shape having the internal hole 32 and an outer member 31b surrounding the inner member 31a. The outer member 31b is fitted in a sealed state to the inner member 31a on its outer periphery that is defined with a helical groove 52, whereby there is formed the aforementioned helical flow duct 40 at the groove 52 between the inner member 31a and the outer member 31b. The flow duct 40 is formed to extend helically in a manner such that it descends helically from the upper to lower areas of the nozzle body 31, turns up at a turnup part 52a in the lower area thereof and then ascends helically upwardly so as not to intersect the descending path. The flow duct 40 is disposed to be located above the gate 38 so that the nozzle constituting part located above the gate 38 can be securely cooled. Further the flow duct 40 communicates at both extremities 40a, 40a thereof with the passageways 27b, 27b for cooling medium formed in the lower runner plate 23 through linking paths 53, 53, as shown in FIG. 2.

The embodiment as described above illustrates that the nozzle block 30 is combined of the nozzle body 31, the cylindrical piece 33 and the nozzle piece 35, but alternatively such an embodiment is also possible that the nozzle piece 35 is provided to be displaceabe so as to advance toward or recede away from the internal hole of the nozzle body 31 by the supply pressure of the molding material, the cylindrical piece being dispensed with. Nevertheless it is preferred, as is the case with the illustrated embodiment, to utilize the cylindrical piece 33 from the viewpoint of easiness upon incorporation of the nozzle piece 35.

According to the nozzle mechanism of the cold runner device for the injection mold arrangement in the embodiment so far described, the nozzle piece 35 at the end part of the nozzle block 30 is loose fitted to the cylindrical piece 33 secured to the nozzle body 31 by threading engagement means and held to be capable of advancing or receding in the feed direction of the molding material. Due to that construction, when the cold runner block 20 is clamped to the upper mold 12 of the mold unit 10 forming the cavity 11, the nozzle piece 35 descends by its deadweight toward the lower part of the cylindrical piece 33, and the tip portion of the nozzle piece 35 protrudes downwardly and concurrently, the tip face abuts on the perimeter of the injection port 15 at the upper mold 12 to the cavity 11 in an opposed manner.

At that time, even if the tip face of the nozzle piece 35 does not completely abut on the perimeter of the injection port 15, upon molding, the nozzle piece 35 is urged by reason of the feed pressure of the molding material 50 to be displaced in the advancing direction as shown in FIG. 5, whereby the tip face is made into press contact with the perimeter of the injection port 15 to the cavity completely and strongly. Consequently, there is no risk of leakage of the molding material 50 such as unvulcanized rubber taking place. Thus the vulcanization molding is possible without causing any leaking of rubber or the like.

Further due to the construction above, when the cold runner block 20 and the upper mold 12 are assembled by clamping of both or by stage switching, there is no longer necessity of faying the tip face of the nozzle piece 35 with the perimeter of the injection port 15 at the upper mold to the cavity, and the adjustment of the opposed abutting state becomes virtually or utterly unnecessary. The assembling work or the stage switching work is thus facilitated to the utmost. If the injection port 15 is disposed in the same location of the upper mold 15, then the same cold runner block can be used to different upper molds, namely it is possible to use the cold runner block in common with every upper mold.

Again due to the fact that the nozzle piece 35 avails itself of the feed pressure of the molding material, merely being loose fitted in the cylindrical nozzle 33 secured by a threading engagement means to the internal hole 32 of the nozzle body 31, the construction of the nozzle piece constituted as a movable type of one is simplified. As a consequence, the incorporation of the nozzle piece 35 as such is facilitated, the nozzle piece can be fabricated at a cheap cost, and besides, the cleaning of the nozzle portion can be performed easily by disassembling the nozzle piece, with the cold runner block 20 remaining present in the pressure device since it will suffice to remove the mold unit 10 from the cold runner block 20 and release the cylindrical piece 33 from the nozzle body 31 by thread disengagement operation. The exchange of the nozzle piece 35 can be likewise conducted easily, as well.

Furthermore, due to the construction that the flow duct 40 for cooling medium for cooling the nozzle block 30 is provided to helically turn around the internal hole 32, it is possible to cool the nozzle block 30 axially uniformly. In particular, in the embodiment described above a fast vulcanizing rubber compound may be used for the inner rubber layer A2 of the bushing A. In that case, if an uneven cooling occurs in the nozzle block 30, there is a danger that the vulcanization of the rubber material progresses at the upper side above the gate 38 to cause the nozzle to plug up, but the helical flow duct 40 constructed as above enables it to enhance the cooling efficiency, thus solving the defect like this.

As an aside, in the foregoing embodiment, the rubber material is injected from the hot runner into the cavity at the first molding stage 101, but the cold runner device can also be used at this first stage to inject the rubber material, as is the case with the second molding stage 102.

[Second Embodiment]

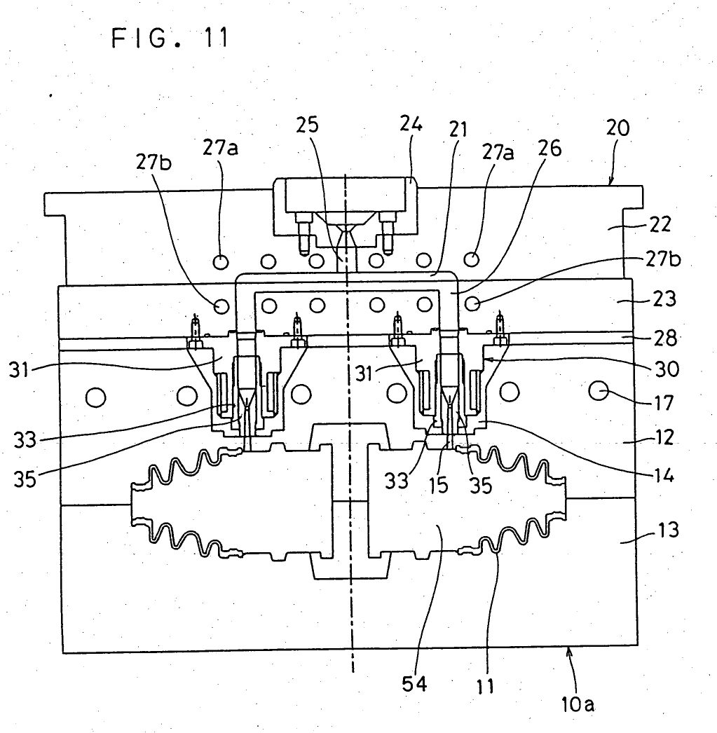

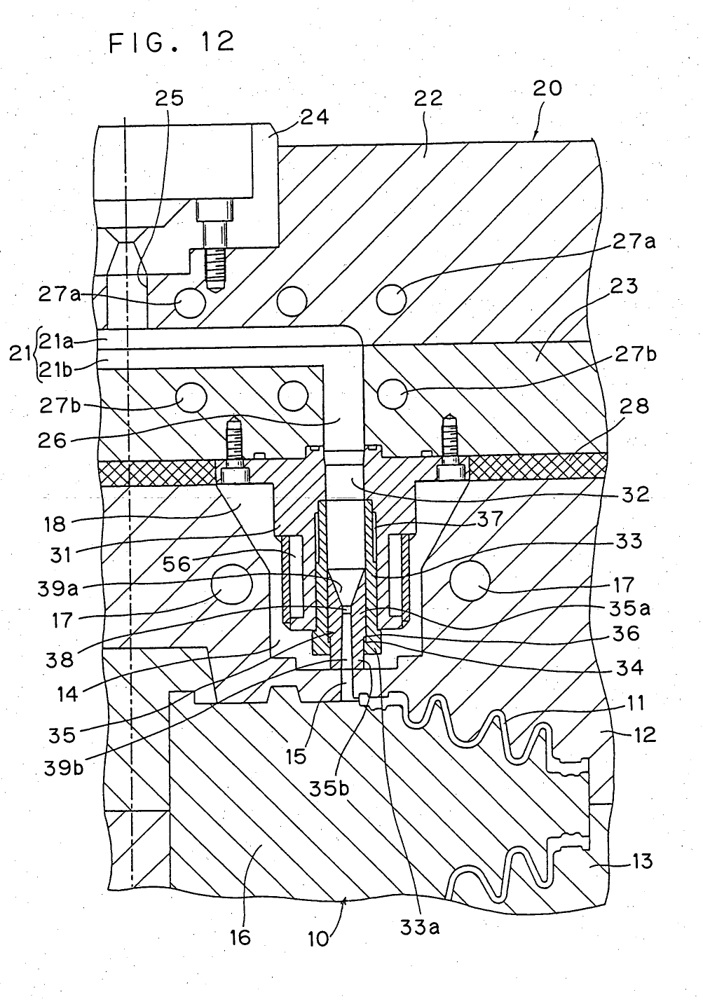

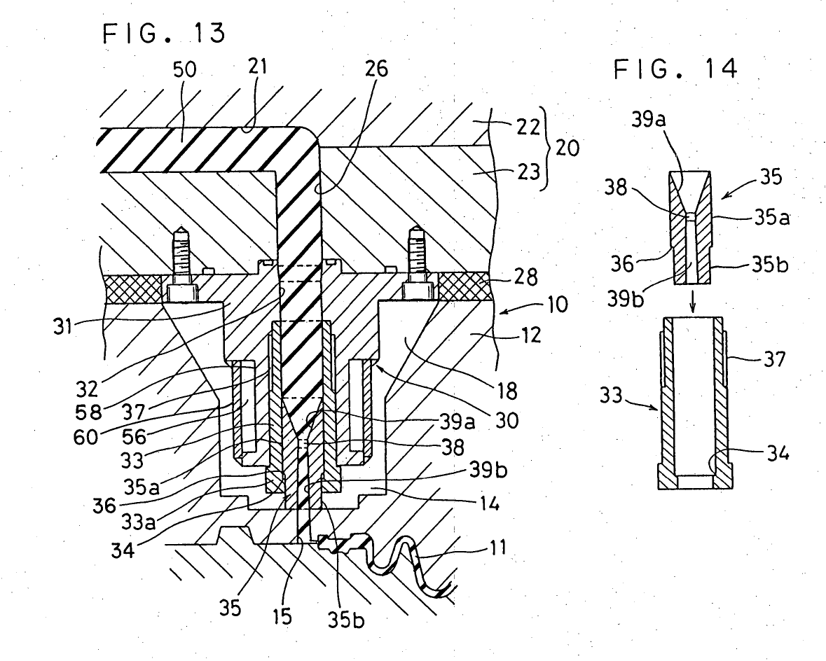

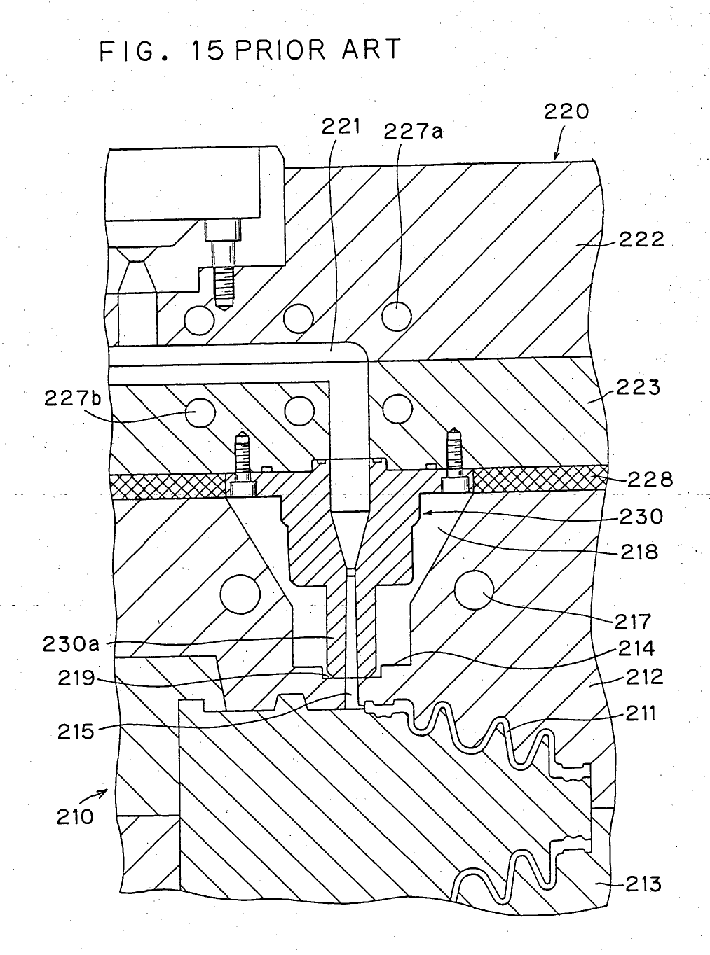

A second embodiment will be now explained with reference to FIGS. 11 to 14. This second embodiment is relevant to a bellows-like rubber boot used for a protective covering, etc. of a shift lever linking part of a vehicle for automobiles. An injection mold unit 10a is fundamentally based on the same construction as the mold unit 10 at the second molding stage 102 in the first embodiment. Consequently as regards like elements designated by like reference numerals as in the first embodiment, their detailed explanation will be omitted as having like construction, unless otherwise stated.

The mold unit 10a in the second embodiment comprises an upper mold 12 as a movable mold connected through a cold runner to a pressure device (not shown), a lower mold 13 as a stationary mold, and a core mold 54; and constructed so that when these are mated together, the cavity 11 for molding the boot may be formed. Usually a plural number of the cavities 11 (two in the figures) are provided, depending upon the material dispensing number (e.g. four-cavity) per one mold unit 10.

In this embodiment, a flow duct 56 for cooling medium in the outer periphery of the nozzle body 31 is not provided helically as is the case with the flow duct 40 in the first embodiment, but formed by a cylindrical enclosure surrounding the perimeter of the internal hole 32. Specifically, a depression 58 of a definite depth is defined axially in the outer periphery of the nozzle body 31, and a cylindrical member 60 covers the outer periphery so as to close the depression 58, whereby forming the flow duct 56 of the cylindrical enclosure with an axially definite thickness

Here, by virtue of the advantage that the flow duct can be formed at low cost, a slow curing rubber compound enables the provision of an inexpensive cold runner device, while preventing the undesired vulcanization of the rubber in the nozzle block 30 from progressing. Also in the nozzle block 30 of this embodiment, it is alternatively possible to provide the helical flow duct 40 similar to that in the first embodiment.

Thus far described, according to the nozzle mechanism of this invention, due to the constitution that the nozzle tip portion is formed of a movable type of nozzle piece separate from the nozzle body, and the tip face of the nozzle piece is constructed to be strongly and securely brought into pressure contact with the perimeter of the injection port to the cavity by availing itself of the feed pressure of the molding material, its construction is simplified, the adjustment of the opposed abutment part upon assembling is hardly or by no means required, the assembling work is facilitated, and a possible leakage of the molding material such as rubber can be reliably prevented. Further the stage switching work can also be conducted with ease.

In particular, by adopting the constitution that the nozzle piece is loose fitted in the cylindrical piece secured to the internal hole of the nozzle body by a threading means, the incorporation of the nozzle piece is facilitated to the utmost and besides the cleaning of the nozzle portion can be conducted easily.

What is claimed is:

1. In an injection mold arrangement which comprises a mold unit including upper and lower molds jointly defining a mold cavity; and a cold runner device comprising a cold runner block attached to the upside of the upper mold through the intermediary of a thermal insulation material layer and forming a cold runner through which to feed a molding material injected from an injection nozzle of an injection machine, and a nozzle block attached to the underside of the cold runner block to constitute an injection nozzle for charging the molding material through the cold runner into the mold cavity,
a nozzle mechanism of the cold runner device constructed so that the nozzle block comprises a nozzle body having an internal hole communicating with the cold runner, and a nozzle piece having a gate formed of a throttle orifice;
the nozzle piece is held within a lower part of the nozzle body so as to be capable of advancing or receding in the feeding direction of the molding material with its lower tip face protruded downwardly;
and a lower tip face of the nozzle piece may be brought into pressure contact with the perimeter of an injection port at the upper mold to the mold cavity by reason of a feeding pressure of the molding material.

2. The nozzle mechanism of the cold runner device in an injection mold arrangement as claimed in claim 1,
wherein a cylindrical piece is secured to the internal hole of the nozzle body by threading engagement means with its lower extremity protruded downwardly; said nozzle piece is loose fitted in said cylindrical piece and held to be capable of advancing or receding in the feeding direction of the molding material, with a lower tip portion thereof protruded downwardly of the lower extremity of the cylindrical piece.

3. The nozzle mechanism of the cold runner device in an injection mold arrangement as claimed in claim 2,
wherein said cylindrical piece has a slightly smaller diameter at its lower end opening part than at its upper part to form a step portion inboard of the lower end opening part;
and said nozzle piece loose fitted in said cylindrical piece is formed to be smaller in diameter at its lower part than at its upper part so as to enable the loose fitting of the lower part into the lower end opening part, thus forming a stepped overhang portion between the upper part and the lower part so that the stepped overhang portion may be engaged with the step portion in the inner periphery of the cylindrical piece, thereby regulating the downward displacement of the nozzle piece.

4. The nozzle mechanism of the cold runner device in an injection mold arrangement as claimed in claim 1,
wherein said nozzle piece assumes a tapered form, with its upper nozzle hole part located above the gate is larger in size than its lower nozzle part located below the gate.

5. The nozzle mechanism of the cold runner device in an injection mold arrangement as claimed in claim 1,
wherein said nozzle block is provided with a flow duct for cooling medium, said flow duct being formed by a flow passage helically turning around said internal hole.
